(19) United States
(12) Patent Application Publication
(10) Pub. No.: US 2018/0156279 A1
(43) Pub. Date: Jun. 7, 2018

(54) BEARING COVER

(71) Applicant: Miba Sinter Austria GmbH, Laakirchen (AT)

(72) Inventors: Manuel Steinmaurer, Steinerkirchen (AT); Oliver Rolf, Gifhorn (DE); Karl Dickinger, Vorchdorf (AT)

(73) Assignee: Miba Sinter Austria GmbH, Laakirchen (AT)

(21) Appl. No.: 15/831,666

(22) Filed: Dec. 5, 2017

(30) Foreign Application Priority Data
Dec. 6, 2016 (AT) A 51106/2016

(51) Int. Cl. F16C 35/02; F16C 17/02; F16C 9/02

(52) U.S. Cl. CPC F16C 35/02; F16C 2226/60; F16C 9/02; F16C 17/022

(57) ABSTRACT

The invention relates to a bearing cover (3) for a split bearing arrangement (1) which comprises a bearing block (2) in addition to the bearing cover (3), and the bearing cover (3) has clamping surfaces (4) which lie against co-operating clamping surfaces (5) of the bearing block (2) when the bearing arrangement (1) is in the assembled state, and a first radially inner bearing support surface (12) having an at least approximately curved cross-section as viewed in the axial direction is provided between the two clamping surfaces (4). An additional surface (15) is provided between at least one of the clamping surfaces (4) and the first radially inner bearing support surface (12) which directly adjoins the first radially inner bearing support surface (12) and clamping surface (4) and which is disposed at an obtuse angle (16) to the first radially inner bearing support surface (12) and at an acute angle (17) to the clamping surface (5).

The invention relates to a bearing cover for a split bearing arrangement which comprises a bearing block in addition to the bearing cover, and the bearing cover has clamping surfaces which lie against co-operating clamping surfaces of the bearing block when the bearing arrangement is in the assembled state, and a first radially inner bearing support surface having an at least approximately arcuate cross-section as viewed in the axial direction is provided between the two clamping surfaces.

The invention further relates to a bearing arrangement with a bearing cover and a bearing block lying against it.

The invention also relates to a method for producing a split bearing arrangement from a bearing cover which is produced so as to have clamping surfaces and a first radially inner bearing support surface and a bearing block which is produced so as to have co-operating clamping surfaces and a second radially inner bearing support surface, and the bearing cover is clamped to the co-operating clamping surfaces of the bearing block by means of the clamping surfaces, after which a bearing bore formed by the first radially inner bearing support surface and the second radially inner bearing support surface is machine finished to obtain a desired dimension, and before being clamped onto the bearing block, the bearing cover is produced so that the first radially inner bearing support surface has a smaller inside width than the inside width of the second radially inner bearing support surface of the bearing block.

Split bearing arrangements with a bearing block and a bearing cover are known from the prior art, for example as a means of mounting a crankshaft. The bearing cover in this instance is screwed to the bearing block by means of threaded bolts. If the bearing cover is not separated from the bearing block by a fracture separation but is produced separately, the clamping surfaces on the bearing cover and the co-operating clamping surfaces on the bearing block are usually of a flat design. Projections may optionally be provided on these clamping surfaces, which are pushed into the co-operating clamping surfaces during the process of clamping the bearing cover and bearing block together. The reverse arrangement of the projections is also possible.

Such split bearing arrangements are known from U.S. Pat. No. 8,690,439 B2 and AT 517 169 A, for example.

The bearing bore in which the bearing (slide bearing or spherical bearing) is accommodated must have a correspondingly high accuracy with few tolerances. For this reason, the bearing bore is finished by machining after the first clamping of the bearing cover and bearing block, for example by drill finishing or boring. The tools used for this purpose are subjected to a high degree of stress given some of the hard materials used.

The objective of the invention is to propose a means whereby the service life of the tools used for machine finishing the bearing bore of a split bearing arrangement can be increased.

The objective is achieved by means of the bearing cover outlined above, wherein an additional surface is provided between at least one of the clamping surfaces and the first radially inner bearing support surface which directly adjoins the first radially inner bearing support surface and clamping surface and which is disposed at an obtuse angle to the first radially inner bearing support surface and at an acute angle to the clamping surface.

The objective is also achieved by the aforementioned bearing arrangement in which the bearing cover is as specified by the invention.

The objective is also achieved on the basis of the aforementioned method, whereby an additional surface is provided on the bearing cover between at least one clamping surface of the bearing cover and the first radially inner bearing support surface, and the additional surface is disposed directly adjoining the first radially inner bearing support surface and clamping surface and extends at an obtuse angle to the first radially inner bearing support surface and at an acute angle to the clamping surface.

By adapting the bearing cover geometry, i.e. by providing the additional surface between the bearing support surface and clamping surface, a “wedge-shaped” entry geometry is created for the cutting tool. The entry of the tool into the material of the bearing cover is therefore “gentler”, as a result of which the service life of the tool can be increased. This bearing cover geometry is of particular advantage in the case of bearing covers made from sintered materials because the edge is compacted to a greater degree in this region, thereby placing even more stress on the tools.

To further improve this effect of a “gentler” entry into the material of the bearing cover, the acute angle may be selected from a range of 1° to 60° based on one embodiment of the bearing cover.

Furthermore, the additional surface of the bearing cover may be at least partially curved. This enables a geometry to be imparted to the bearing cover which on the one hand enables a gentle entry but on the other hand enables a relatively large amount of material to be removed.

For the same reason, the transition between the clamping surface and the additional surface and/or the transition between the first radially inner bearing support surface and the additional surface may be provided with a curvature.

Based on one embodiment of the bearing arrangement, the clamping surfaces cooperate with co-operating clamping surfaces on the bearing block, between which a second radially inner bearing support surface is formed, and the transition from the co-operating clamping surfaces to the second radially inner bearing support surface in the radial direction is inwardly offset from the transition between the clamping surface and the first radially inner bearing support surface of the bearing cover. As a result, a projection which is of advantage in terms of obtaining the nominal pitch of the tool does not have to be removed in order to fit the friction bearing (bush or half-shell).

To provide a clearer understanding, the invention will be described in more detail below with reference to the appended drawings.

These are simplified, schematic diagrams respectively illustrating the following:

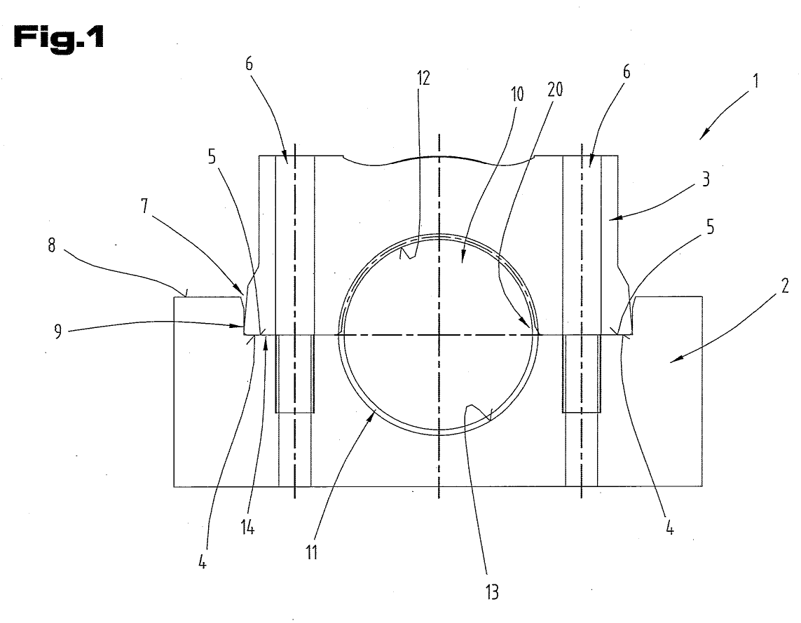

FIG. 1 an axial view of a split bearing arrangement;

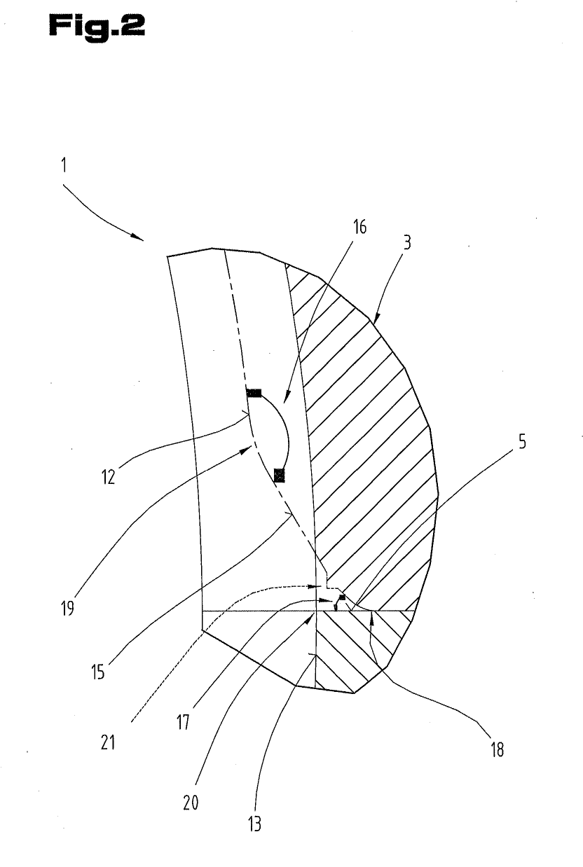

FIG. 2 a detail of the bearing arrangement illustrated in FIG. 1;

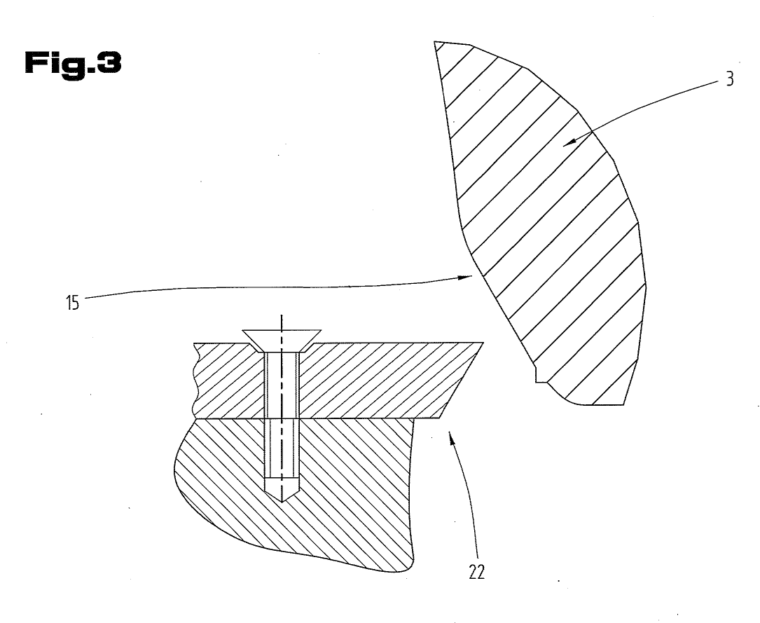

FIG. 3 a detail of the bearing arrangement illustrated in FIG. 1 with a cutting tool.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 illustrates a split bearing arrangement 1 such as might be used in an engine housing of a reciprocating piston engine or a piston rod, for example. This bearing arrangement 1 comprises a bearing block 2 and a bearing cover 3.

The bearing cover 3 has a clamping surface 4 at each of its two distal end regions and the bearing block 2 has co-operating clamping surfaces 5 at each of its two end regions lying opposite the clamping surfaces 5, which define the separation plane of the split bearing arrangement 1 and lie in contact with one another when the bearing arrangement 1 is in the assembled state.

In order to clamp the bearing block 2 to the bearing cover 3, a continuous bore 6 is provided in each of the distal end regions of the bearing cover 3. Seated in this bore 6 is a bolt. The bolt engages in a thread of a blind bore in the bearing block 2, thereby producing the clamping action. Alternatively, the bore in the bearing block 2 may be end-to-end and optionally may not have an internal thread. In this case, the clamping action is obtained using an appropriate nut fitted on the bolt underneath the bearing block 2.

The bearing block 2 has a recess 7 in which the bearing cover 3 is seated. The cooperating clamping surface 5 of the bearing block 2 therefore sits downwardly offset from an external face 8. The recess 7 is laterally bounded by side walls 9. The co-operating clamping surface 5 forms the bottom end in the region in contact with the bearing cover 3.

The recess 7 has a lead-in chamfer in the region of the side walls 9.

However, another option is one where the bearing block 2 is not provided with this recess 7. In this case, the co-operating clamping surfaces 5 directly adjoin the external face 8 and lie in a same plane.

Another option is one where the bearing block 2 is of a wider design than the bearing cover 3 in the axial direction (perpendicular to the paper plane of FIG. 1) and the bearing block 2 sits laterally around the bearing cover 3, thereby enabling the bearing cover 3 to be axially secured.

Together, the bearing block 2 and bearing cover 3 form a bearing bore 10 in which a friction bearing 11, for example a crankshaft, may be disposed. The friction bearing 11 may be provided in the form of a bush or in the form of friction bearing shells, in particular friction bearing half-shells. However, it would also be possible to provide ball bearings in the bearing bore 10. Another possible option is to produce the friction bearing 11 by means of a direct coating of the corresponding surfaces of the bearing block 2 and bearing cover 3.

The bearing bore of the split bearing arrangement 1 is formed on the one hand by a first radially inner bearing support surface 12 of the bearing cover 3 and on the other hand by a second radially inner bearing support surface 13 of the bearing block 2.

The first and second bearing support surfaces 12, 13 are provided with an at least approximately arcuate cross-section as viewed in the axial direction.

Protruding out from the clamping surfaces 4 is at least one (cut edge-type) projection 14 per clamping surface 4, which is pressed into the co-operating clamping surface 5 of the bearing block 2 when the bearing arrangement is in the assembled state by clamping the bearing block 2 and bearing cover 3. The projections 14 may be disposed on the clamping surface 4 on the side of the bores 6 facing away from the friction bearing 11 but could optionally or in addition also be disposed on the side of the bore 6 facing the friction bearing 11.

At least the projections 14 are made from a material that is harder than the material of the bearing block 2 in the region of the co-operating clamping surface 5 so that these projections 14 can be pushed into the co-operating clamping surface 5 by pushing together and clamping the bearing block 2 and bearing cover 3. However, it is preferable if the entire bearing cover 3 is made from this harder material. For example, the bearing cover 3 may be made from a ferrous material and the bearing block 2 from a lightweight metal. In particular, the bearing cover 3 is made from a sintered ferrous material. However, another possibility is the converse situation, in which case the bearing block 2 is made from a harder material than the bearing cover 3. In this case, the projections 14 are preferably disposed on the cooperating clamping surfaces 5.

The second radially inner bearing support surface 13 of the bearing block 2 directly adjoins the co-operating clamping surfaces 5. By contrast with this arrangement, an additional surface 15 is provided between the first radially inner bearing support surface 12 of the bearing cover 3 and at least one of the clamping surfaces 4, preferably both clamping surfaces 4, as may be seen more clearly from FIG. 2 illustrating detail “A” from FIG. 1.

FIGS. 1 and 2 illustrate the split bearing arrangement 1 in the state after the first clamping operation and before the two bearing support surfaces 12, 13 have been machine finished. Consequently, the first radially inner bearing support surface 12 of the bearing cover 3 still has an inside width that is smaller than it will be after machine finishing. This is illustrated by the fact that the first radially inner bearing support surface is indicated by broken lines in FIGS. 1 and 2.

The additional surface 15 directly adjoins the clamping surface 5 on the one hand and directly adjoins the first radially inner bearing support surface 12 of the bearing cover 3 on the other hand. Furthermore, it subtends an obtuse angle 16 with the first radially inner bearing support surface 12 and an acute angle 17 with the clamping surface 5. The angles 16, 17 should be viewed as illustrated in FIG. 2. (If viewing the complementary angles to these, then angle 16 would be acute and angle 17 obtuse).

The acute angle 17 between the clamping surface 4 (and hence the separation plane between the bearing cover 3 and bearing block 2) may have a value within a range of between 1° and 89°. However, the acute angle 17 is preferably selected from a range of 1° to 60°.

The obtuse angle 16 between the first radially inner bearing support surface 12 and the additional surface 15 may be selected from a range of 91° and 179°, in particular from a range of 110° and 130°.

Furthermore, as indicated by a second broken line in FIG. 2, the additional surface 15 may be at least partially curved, preferably with a convex curvature, in particular with a convexity in the direction towards the center point of the bearing bore 10 (FIG. 1).

Furthermore, a first transition 18 between the clamping surface 4 and the additional surface 15 and/or a second transition 19 between the first radially inner bearing support surface 12 and the additional surface 15 may be provided with a curvature and optionally the region of the additional surface 15 between the curvatures extends linearly in cross-section (viewed in the axial direction).

The curvature of the first transition 18 may be provided with a smaller radius of curvature than the curvature of the second transition 19. In particular, the curvatures may have a radius of curvature selected from a range of from 0.2 mm to 10 mm, in particular from a range of 0.5 mm to 4 mm.

Based on one embodiment of the split bearing arrangement 1, as may be seen from FIGS. 1 and 2, it is possible that a transition 20 from the co-operating clamping surfaces 5 to the second radially inner bearing support surface 13 in the radial direction is inwardly offset from the transition 18 between the clamping surface and the first radially inner bearing support surface 12 of the bearing cover 3.

As may be seen from FIG. 2 in particular, a projection 21 (a so-called sintered projection) may be provided on the additional surface 15. This projection 21 is optionally provided with a view to obtaining the nominal pitch of the tool when producing the bearing cover 3. This projection 21 is preferably located above the cooperating clamping surface 5, as may be seen in FIG. 2.

The bearing cover 3 is preferably produced by a sintering process. Such sintering processes are known from the prior art and further explanation is therefore not necessary.

In this respect, after the powder compaction process, sintering and optionally another compaction process and/or calibration, the first radially inner bearing support surface 12 of the bearing cover 3 still has only a rough dimension. After the first operation of clamping the bearing cover 3 onto the bearing block 2, the first radially inner bearing support surface 12 can then be adapted to the dimension of the second radially inner bearing support surface 13 of the bearing block 2 by a finishing process and/or precision machining, in other words adapted to a desired dimension. The inside width of the first radially inner bearing support surface 12 of the bearing cover 3 is therefore still smaller than the inside width of the second radially inner bearing support surface 13 of the bearing block 2 immediately after producing the bearing cover 3 by the sintering process.

The process of finishing the first radially inner bearing support surface 12 of the bearing cover 3 to obtain the desired dimension is carried out using a cutting tool 22, for example by drill finishing. This is illustrated in FIG. 3, although the cutting tool 22 has not yet been engaged. However, what can be seen from this drawing of FIG. 3 is that the additional surface 15 of the bearing cover 3 described above enables a more gentle entry of the cutting tool 22 into the bearing cover 3. The additional surface 15 may therefore also be described as a “lead-in chamfer” for the cutting tool 22.

The embodiments described and illustrated as examples represent possible embodiments and it should be noted at this stage that combinations of the individual embodiments with one another are also possible.

For the sake of good order, finally, it should be pointed out that in order to provide a clearer understanding of the design of the split bearing arrangement 1, it is not necessarily illustrated to scale.

### LIST OF REFERENCE NUMBERS

1 Bearing arrangement
2 Bearing block
3 Bearing cover
4 Clamping surface
5 Co-operating clamping surface
6 Bore
7 Recess
8 External face
9 Side wall
10 Bearing bore
11 Friction bearing
12 Bearing support surface
13 Bearing support surface
14 Projection
15 Surface
16 Angle
17 Angle
18 Transition
19 Transition
20 Transition
21 Projection

1. Bearing cover (3) for a split bearing arrangement (1) which comprises a bearing block (2) in addition to the bearing cover (3), and the bearing cover (3) has clamping surfaces (4) which lie against co-operating clamping surfaces (5) of the bearing block (2) when the bearing arrangement (1) is in the assembled state, and a first radially inner bearing support surface (12) having an at least approximately arcuate cross-section as viewed in the axial direction is provided between the two clamping surfaces (4), wherein an additional surface (15) is provided between at least one of the clamping surfaces (4) and the first radially inner bearing support surface (12) which directly adjoins the first radially inner bearing support surface (12) and clamping surface (4) and which is disposed at an obtuse angle (16) to the first radially inner bearing support surface (12) and at an acute angle (17) to the clamping surface (5).

2. Bearing cover (3) according to claim 1, wherein the acute angle (17) is selected from a range of 1° to 60°.

3. Bearing cover (3) according to claim 1, wherein the additional surface (15) is at least partially curved.

4. Bearing cover (3) according to claim 3, wherein a transition (18) between the clamping surface (4) and the additional surface (15) and/or a transition (19) between the first radially inner bearing support surface (12) and the additional surface (15) is provided with a curvature.

5. Bearing arrangement (1) having a bearing cover (3) and a bearing block (2) lying thereon, wherein the bearing cover (3) is of the type according to claim 1.

6. Bearing arrangement (1) according to claim 5, wherein the clamping surfaces (4) co-operate with cooperating clamping surfaces (5) on the bearing block (2), between which a second radially inner bearing support surface (13) is formed, and a transition (20) from the co-operating clamping surfaces (5) to the second radially inner bearing support surface (13) in the radial direction is inwardly offset from the transition (18) between the clamping surface (4) and the first radially inner bearing support surface (12) of the bearing cover (3).

7. Method for producing a split bearing arrangement (1) from a bearing cover (3) produced so as to have clamping surfaces (4) and a first radially inner bearing support surface (12) and a bearing block (2) produced so as to have cooperating clamping surfaces (5) and a second radially inner bearing support surface (13), and the bearing cover (3) is clamped to the co-operating clamping surfaces (5) of the bearing block (2) by means of the clamping surfaces (4), after which a bearing bore (10) formed by the first radially inner bearing support surface (12) and the second radially inner bearing support surface (13) is machine finished to obtain a desired dimension, and before being clamped onto the bearing block (2), the bearing cover (3) is produced so that the first radially inner bearing support surface (12) has a smaller inside width than the inside width, of the second radially inner bearing support surface (13) of the bearing block (2), wherein an additional surface (15) is provided on the bearing cover (3) between at least one clamping surface (4) of the bearing cover (3) and the first radially inner bearing support surface (12), and the additional surface (15) directly adjoins the first radially inner bearing support surface (12) and clamping surface (4) and extends at an obtuse angle (16) to the first radially inner bearing support surface (12) and at an acute angle to the clamping surface (4).
